(19) United States
(12) Patent Application Publication
(10) Pub. No.: US 2016/0176694 A1
(43) Pub. Date: Jun. 23, 2016

(54) SYSTEM AND METHOD FOR BEVERAGE DISPENSER ALERT

(71) Applicant: John Alexander Vinci, Prospect, KY (US)

(72) Inventor: John Alexander Vinci, Prospect, KY (US)

(21) Appl. No.: 14/961,881

(22) Filed: Dec. 7, 2015

Related U.S. Application Data
(60) Provisional application No. 62/094,171, filed on Dec. 19, 2014.

(51) Int. Cl. B67D 1/08

(52) U.S. Cl. CPC B67D 1/0888; B67D 1/0801; B67D 2001/0827

(57) ABSTRACT

A system and method for a beverage dispenser alert according to one example embodiment includes a power source, a vacuum switch connected to the power source and an alert connected to the vacuum switch and the power source. The vacuum switch is set to complete a circuit with the power source and the alert when the vacuum switch detects a pressure in a beverage line indicating that a beverage product bag should be replaced and when an amount of beverage product remains in the beverage line.

### CROSS-REFERENCE TO RELATED APPLICATIONS

This application claims priority to U.S. Provisional Application No. 62/094,171, entitled “System and Method for Beverage Dispenser Alert” and filed on Dec. 19, 2014, which is incorporated by reference herein in its entirety.

### BACKGROUND

1. Field of the Disclosure

The present invention relates to systems and methods for a beverage dispenser alert.

2. Description of the Related Art

Many beverage dispenser systems use bags contained in boxes to store beverage product. Often, the bags are placed out of the sight of beverage customers, such as on storage racks, for example. Pumps typically suck the beverage product out of the bags and move it through tubes that run through walls or in the ceiling from the storage racks to dispensers where the beverage product is mixed with carbonated water to form carbonated beverages. As a beverage product bag empties, it collapses until the air and beverage product are sucked out of it. The pumps usually are set to stop when the vacuum pressure reaches a value that indicates that there is no more liquid in the beverage product bag.

Currently, staff members learn that beverage product bags are empty through visual and manual inspections or when a beverage customer notifies a staff member that a beverage is not being dispensed. Visual and manual inspections typically are performed on multiple beverage product bags several times a day. Further, manual inspections involve feeling each of the bags in the boxes to see if any of the bags are empty. These inspections are time consuming and inconvenient. Moreover, if a relatively small amount of beverage product remains in a bag at the time of an inspection, staff members often replace the bag and dispose of the bag with beverage product still in it to avoid coming back to replace the bag later. Such early replacement of the beverage product bag results in a loss of beverage product.

Also, when the beverage product bags are empty, a carbon dioxide and water mixture continues to be carried through tubes to the dispensers. If a beverage product bag is not replaced when it is empty, the carbon dioxide and water mixture often is released at the dispensers and wasted, and beverage quality and flavoring is altered.

In addition, when customers notice that beverages are not being dispensed and notify staff members of beverage outages, it harms customer relations, disrupts business and causes delays.

Therefore, a significant obstacle with beverage dispenser systems is detecting beverage outages. Accordingly, it will be appreciated that a beverage dispenser alert that assists with detecting beverage outages is desired.

### SUMMARY

A beverage dispenser alert system according to one example embodiment includes a power source, a vacuum switch connected to the power source and an alert connected to the vacuum switch and the power source. The vacuum switch is set to complete a circuit with the power source and the alert when the vacuum switch detects a pressure in a beverage line indicating that a beverage product bag should be replaced and when an amount of beverage product remains in the beverage line.

A beverage dispenser alert system according to another example embodiment includes a power source, a vacuum switch connected to the power source and an alert connected to the vacuum switch and the power source. The vacuum switch is set to complete a circuit with the power source and the alert when the vacuum switch detects a pressure in a beverage line indicating that a beverage product bag should be replaced, and the alert is positioned at a distance from the beverage line.

A beverage dispenser alert system according to another example embodiment includes a power source, a vacuum switch connected to the power source and an alert connected to the vacuum switch and the power source. The vacuum switch is set to complete a circuit with the power source and the alert when the vacuum switch detects a pressure in a beverage line indicating that a beverage product bag should be replaced and when an amount of beverage product remains in the beverage product bag.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is an exploded view of a beverage dispenser alert system according to multiple embodiments and alternatives; and

FIG. 2 is a perspective view of a beverage dispenser alert system according to multiple embodiments and alternatives.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, electronic, process and other changes. Examples merely typify possible variations. Individual components and functions are optional unless explicitly required, and the sequence of operations may vary. Portions and features of some embodiments may be included in or substituted for those of others. The following description is, therefore, not to be taken in a limited sense.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings and mountings. In addition, the terms “connected” and “coupled” and variations thereof are not restricted to physical or mechanical connections or couplings.

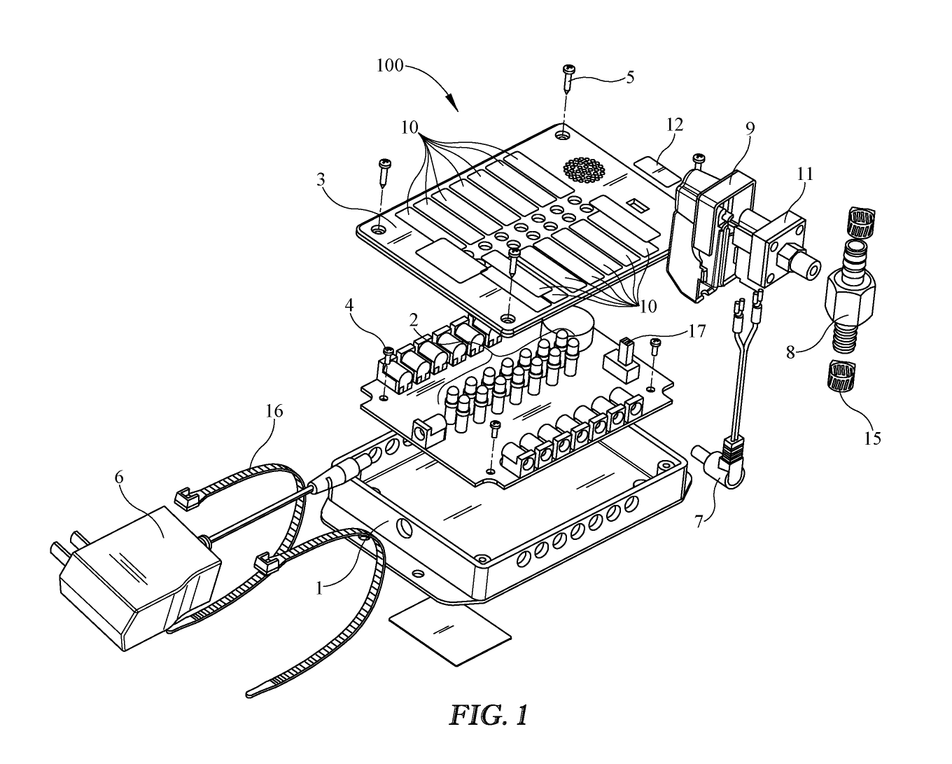

Turning now to the drawings, and more particularly to FIG. 1, an example embodiment of a beverage dispenser alert system 100 is illustrated. The beverage dispenser alert system 100 includes a power source 6, an alert 2 and a vacuum switch 11. The power source 6, the vacuum switch 11 and the alert 2 are positioned to form an electrical circuit that is complete when the switch 11 detects a selected pressure value and actuates.

In some embodiments, the power source 6 may be an electrical power source, such as a battery or a connection to an electrical power outlet, for example. In some embodiments, the alert 2 may be an audible alarm, such as a buzzer, chime, ringer or bell, for example. In certain embodiments, the alert 2 may include a volume switch 17 with high and low volume settings, for example. In some embodiments, the alert 2 may be a visible indicator, such as a light-emitting diode (LED) or light bulb, for example. In other embodiments, the alert 2 may include both an audible alarm and a visible indicator. In certain embodiments, the alert 2 may include an audible alarm that indicates that any of several beverage product bags should be replaced and a visible indicator that indicates which of the several beverage product bags should be replaced. Persons of skill in the art will appreciate that the alert 2 also may take a variety of other forms.

In some embodiments, the selected pressure value for the vacuum switch 11 may be between about 15 inHg and 20 inHg. In certain embodiments, the selected pressure value for the vacuum switch 11 may be about 16 inHg. In some embodiments, for example at high altitude locations, the selected pressure value for the vacuum switch 11 may be between about 11 inHg and about 14 inHg. Persons of skill in the art will appreciate that the selected pressure also may be a variety of other values.

In some embodiments, the beverage dispenser alert system 100 includes a base 1 and a cover 3. In certain embodiments, the alert 2 is positioned between the base 1 and the cover 3. The base 1 and the cover 3 may be made from any of a variety of materials and in any of a variety of shapes. In some embodiments, the base 1 and the cover 3 may be made from polymers or metals. In certain embodiments, the base 1 and the cover 3 may be connected, such as using screws 4 and 5, for example. In certain embodiments, the cover 3 may include labels 10 corresponding to various beverage products, such as cola, iced tea and root beer, for example. In certain embodiments, the cover 3 may include a sound label 12 corresponding to the high and low volume settings on the volume switch 17.

In some embodiments, the beverage dispenser alert system 100 includes a wire harness 7 connected to and between the alert 2 and the vacuum switch 11. In certain embodiments, the wire harness 7 may have a length of about 6 ft.

In some embodiments, the beverage dispenser alert system 100 also includes a sensor cover 9 to protect the vacuum switch 11. In certain embodiments, the sensor cover 9 is positioned over or partially over the vacuum switch 11. The sensor cover 9 may be made from any of a variety of materials and in any of a variety of shapes. In some embodiments, the sensor cover 9 may be made from polymers or metals.

In some embodiments, the beverage dispenser alert system 100 also includes a harness 16 to mount or attach the beverage dispenser alert system 100 to a storage rack, for example. In certain embodiments, the harness may be zip ties made from a polymer, for example.

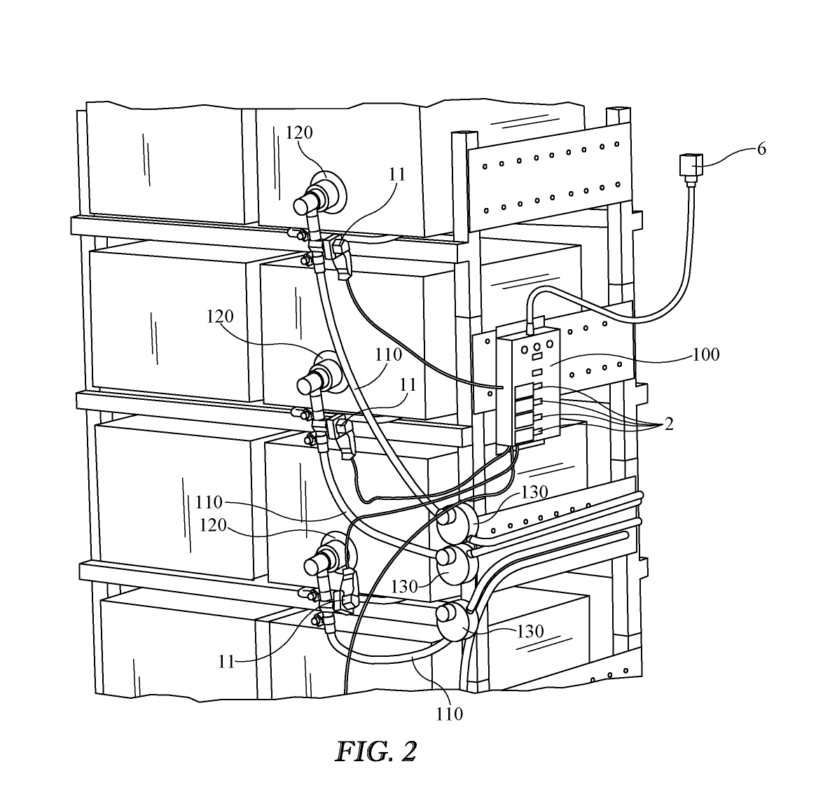

As shown in FIG. 2, in multiple embodiments, the beverage dispenser alert system 100 may be connected to a beverage line 110 between a beverage product bag 120 and a beverage pump 130. The beverage line 110, the beverage product bag 120 and the beverage pump 130 may be made from any of a variety of materials and in any of a variety of shapes. In some embodiments, the beverage line 110 and the beverage pump 130 may be made from polymers and metals, and the beverage product bag 120 may be made from polymers.

In some embodiments, the beverage product bag 120 contains beverage syrup, such as for cola, orange soda, diet soda, root beer or iced tea, for example. In some embodiments, pressure from carbon dioxide in tanks may power the pump 130. In certain embodiments, the pump 130 may suck the syrup out of the bag 120 and move it through the line 110 to dispensers, where the syrup may be mixed with carbonated water to form carbonated beverages. As the bag 120 empties, it collapses until the air and beverage product are sucked out of it. The pump 130 may be set to stop when the vacuum pressure in the beverage line 110 reaches a value indicating that there is approximately no more beverage product in the bag 120. Also, in the beverage dispenser alert system 100, the vacuum switch 11 may be set to complete the circuit with the power source 6 and the alert 2 when the vacuum switch 11 detects a pressure in the beverage line 110 indicating that approximately no beverage product remains in the bag 120.

In some embodiments, the vacuum switch is connected to the beverage line 110, and the power source, the alert and the vacuum switch of the beverage dispenser alert system 100 are positioned near the beverage line 110. As illustrated in FIG. 2, in some embodiments, the vacuum switch 11 is connected to and positioned near the beverage line 110, and the power source 6 and the alert 2 are positioned at a distance from the beverage line 110. In such embodiments, the power source 6 may be connected to a plurality of vacuum switches and alerts, and each of the vacuum switches and alerts may be connected to a different beverage line.

In some embodiments, the beverage dispenser alert system 100 is integrally formed with the beverage pump 130. In some embodiments, the beverage dispenser alert system 100 is integrally formed with the beverage line 110 between the beverage product bag 120 and the beverage pump 130. In some embodiments, the beverage dispenser alert system 100 is connected to the beverage line 110 using a split device 8 (shown in FIG. 1) and clamps 15 (shown in FIG. 1). In certain embodiments, the split device 8 is positioned in the beverage line 110 and held with clamps 15, and the split device 8 is connected to the beverage dispenser alert system 100.

The split device 8 and the clamps 15 may be made from any of a variety of materials and in any of a variety of shapes. In some embodiments, the split device 8 and the clamps 15 may be made from polymers or metals, such as stainless steel, for example. In certain embodiments, the split device 8 may be made in a tee shape, and the clamps 15 may be made in a circle shape.

In some embodiments, the beverage dispenser alert system 100 may be installed on existing beverage lines 110. In some such embodiments, the beverage dispenser alert system 100 is installed by first disconnecting the beverage lines from the beverage product bags. Next, the dispensers are run at the fountain for about 5 seconds to draw the beverage products down the beverage lines and to clear space in the beverage lines near the beverage product bags. In certain embodiments, a check valve located in a beverage product bag connector is depressed to allow a small amount of air into the beverage line to push the beverage product down the beverage line. Then, the carbon dioxide supply to the beverage pumps is turned off. Next, the beverage lines are cut near the beverage product bags. Then, the clamps 15 are inserted over the beverage lines near both of the ends that were formed when the lines were cut, and the split devices 8 are inserted into the beverage lines at such ends. The clamps 15 are then tightened to prevent any air from entering the system. Next, the wire harnesses 7 (shown in FIG. 1) are plugged into the alert 2, and the corresponding beverage products are listed on the labels 10 (shown in FIG. 1). The carbon dioxide supply to the beverage pumps is then turned on. Then, the power supply 6 is plugged into an electrical power outlet.

In use, the vacuum switch 11 actuates and completes the electrical circuit with the power source 6 and the alert 2 when the vacuum pressure in the beverage line 110 reaches a value that indicates that the beverage product bag 120 should be replaced. The alert 2 then receives power from the power source 6 and indicates that the beverage product bag 120 should be replaced. In some embodiments, the alert 2 includes an audible alarm that indicates that one of several beverage product bags should be replaced and a visible indicator that indicates which of the several beverage product bags should be replaced.

In some embodiments, the vacuum switch actuates when the vacuum pressure in the beverage line 110 reaches a value that triggers the pump 130 to stop. In some embodiments, an amount of beverage product remains in the line 110 after the beverage product bag 120 is empty and after the vacuum switch actuates, allowing an amount of time after the alert 2 indicates that the beverage product bag 120 should be replaced before a beverage outage occurs at the dispenser. In some embodiments, an amount of beverage product remains in the beverage product bag 120 after the vacuum switch actuates, allowing an amount of time after the alert 2 indicates that the beverage product bag 120 should be replaced before a beverage outage occurs at the dispenser.

Once the beverage product bag 120 is replaced, the vacuum pressure in the beverage line 110 returns to a value indicating that beverage product is in the bag 120. At such pressure value, the vacuum switch 11 deactivates, causing the alert 2 to lose power and shut off, and the pump 130 reactivates.

It will be appreciated that the beverage dispenser alert system 100 may be used to assist with detecting beverage outages. The alert system 100 provides a convenient, efficient and cost-effective method to indicate that a beverage product bag should be replaced. Thus, the alert system 100 helps avoid the early replacement of the beverage product bag and the loss of beverage product. The alert system 100 also helps prevent the release and waste of carbon dioxide and water when the beverage product bag is empty. In addition, the alert system 100 improves customer relations and reduces business disruptions and delays.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. A beverage dispenser alert system, comprising:
a power source;
a vacuum switch connected to the power source; and
an alert connected to the vacuum switch and the power source, wherein the vacuum switch is set to complete a circuit with the power source and the alert when the vacuum switch detects a pressure in a beverage line indicating that a beverage product bag should be replaced and when an amount of beverage product remains in the beverage line.

2. The beverage dispenser alert system of claim 1, wherein the alert includes an audible alarm.

3. The beverage dispenser alert system of claim 1, wherein the alert includes an audible alarm and a visible indicator.

4. The beverage dispenser alert system of claim 1, wherein the alert includes an audible alarm that indicates that one of a plurality of beverage product bags should be replaced and a visible indicator that indicates which of the plurality of beverage product bags should be replaced.

5. The beverage dispenser alert system of claim 1, wherein the pressure indicating that the beverage product bag should be replaced is between about 15 inHg and 20 inHg.

6. The beverage dispenser alert system of claim 1, wherein the beverage dispenser alert system is connected to the beverage line between the beverage product bag and a beverage pump.

7. The beverage dispenser alert system of claim 1, wherein the vacuum switch is connected to and positioned near the beverage line and wherein the power source and the alert are positioned at a distance from the beverage line.

8. The beverage dispenser alert system of claim 1, wherein the power source is connected to a plurality of vacuum switches and alerts and each of the plurality of vacuum switches is connected to a beverage line.

9. The beverage dispenser alert system of claim 1, wherein the beverage dispenser alert system is connected to the beverage line using a split device and clamps.

10. A beverage dispenser alert system, comprising:
a power source;
a vacuum switch connected to the power source; and
an alert connected to the vacuum switch and the power source, wherein the vacuum switch is set to complete a circuit with the power source and the alert when the vacuum switch detects a pressure in a beverage line indicating that a beverage product bag should be replaced and wherein the alert is positioned at a distance from the beverage line.

11. The beverage dispenser alert system of claim 10, wherein the alert includes an audible alarm.

12. The beverage dispenser alert system of claim 10, wherein the alert includes an audible alarm and a visible indicator.

13. The beverage dispenser alert system of claim 10, wherein the alert includes an audible alarm that indicates that one of a plurality of beverage product bags should be replaced and a visible indicator that indicates which of the plurality of beverage product bags should be replaced.

14. The beverage dispenser alert system of claim 10, wherein the pressure indicating that the beverage product bag should be replaced is between about 15 inHg and 20 inHg.

15. The beverage dispenser alert system of claim 10, wherein the beverage dispenser alert system is connected to the beverage line between the beverage product bag and a beverage pump.

16. The beverage dispenser alert system of claim 10, wherein the power source is connected to a plurality of vacuum switches and alerts and each of the plurality of vacuum switches is connected to a beverage line.

17. A beverage dispenser alert system, comprising:
a power source;
a vacuum switch connected to the power source; and
an alert connected to the vacuum switch and the power source, wherein the vacuum switch is set to complete a circuit with the power source and the alert when the vacuum switch detects a pressure in a beverage line indicating that a beverage product bag should be replaced and when an amount of beverage product remains in the beverage product bag.

18. The beverage dispenser alert system of claim 17, wherein the alert includes an audible alarm that indicates that one of a plurality of beverage product bags should be replaced and a visible indicator that indicates which of the plurality of beverage product bags should be replaced.

19. The beverage dispenser alert system of claim 17, wherein the beverage dispenser alert system is connected to the beverage line between the beverage product bag and a beverage pump.

20. The beverage dispenser alert system of claim 17, wherein the vacuum switch is connected to and positioned near the beverage line and wherein the power source and the alert are positioned at a distance from the beverage line.
